(19) United States
(12) Patent Application Publication
(10) Pub. No.: US 2015/0192923 A1
(43) Pub. Date: Jul. 9, 2015

(54) SYSTEM AND METHODS FOR ELECTROWETTING BASED PICK AND PLACE

(71) Applicant: Cornell University, Ithaca, NY (US)

(72) Inventors: Fnu Apoorva, Ithaca, NY (US); Robert MacCurdy, Ithaca, NY (US); Hod Lipson, Ithaca, NY (US)

(21) Appl. No.: 14/415,414

(22) PCT Filed: Jul. 16, 2013
(86) PCT No.: PCT/US13/50650

§ 371 Date: Jan. 16, 2015

Related U.S. Application Data
(60) Provisional application No. 61/672,111, filed on Jul. 16, 2012.

(51) Int. Cl. G05B 19/418

(52) U.S. Cl. CPC G05B 19/4189

(57) ABSTRACT

A system based on electrowetting facilitates high-volume assembly of objects including micron sized objects. A material handling component of the system includes an array of electrically controlled nodes that switch their adhesion property based on a voltage supply. The system accurately picks up and places objects including in parallel.

### PRIORITY CLAIM

This application claims the benefit of U.S. Provisional Patent Application Ser. No. 61/672,111 filed Jul. 16, 2012.

### GOVERNMENT FUNDING

The invention described herein was made with government support under grant number W911NF-11-1-0093, awarded by the Defense Advanced Research Projects Agency (DARPA). The United States Government has certain rights in the invention.

### FIELD OF THE INVENTION

The invention relates generally to pick and place system and methods in which objects are picked from one location, transferred to another location, and placed in a precise position. More specifically, the invention relates to system and methods for object manipulation that utilizes electrowetting in order to easily, carefully, and quickly pick and place objects, including micron sized objects, with precision.

### BACKGROUND OF THE INVENTION

Automated manufacturing processes often include a mechanism that picks or selects an object and transfers it from one location to another in order for the object to be placed in a precise position.

There have been a number of devices invented in order to move hundreds of small objects. Some look at pick and place robotics to individually grasp and move each piece quickly, while others rely on self-assembly through energy minima. From suction to magnets to tweezers, numerous products attempt to quickly move large amounts of small objects efficiently and carefully. However, there is a limitation on size. Once objects get too small, for example, around the range of a millimeter and smaller, it becomes more difficult to handle these delicate objects and to quickly arrange the objects in a desired accurate configuration. Furthermore, most inventions use single end effectors to pick up objects—greatly increasing the time to move objects—when two or more objects could be moved in parallel and in any configuration or pattern if properly controlled.

There is a demand for a system and methods that can easily, carefully, and quickly manipulate micron sized objects such as picking and placing objects individually and in parallel as well as in any configuration or pattern. The invention satisfies this demand.

### SUMMARY OF THE INVENTION

The invention is directed to a system and methods that utilizes electrowetting to manipulate one or more objects including micron sized objects. For purposes of this application, a micron sized object is a very small object, for example, an object with a size around, about, or less than one thousandth of a meter (millimeter) or one-millionth of a meter (micrometer).

Electrowetting refers to modification in wetting property of a surface induced by an externally applied electric field. The invention includes a plurality of electrically controlled nodes that switch their adhesion property depending on the voltage supply. Specifically, the electrically controlled nodes display hydrophilic forces to pick-up objects and reverse to hydrophobic forces to place objects.

Nodes comprise an electrode element. In order for the nodes to display hydrophilic forces or hydrophobic forces, the electrode element is coated with a dielectric element and a hydrophobic element. The micron sized objects to be picked up must be coated with a substance referred to herein as “droplet”. The droplet is of a substance that can be electrically controlled, for example, water.

Specifically, the electrically controlled nodes are hydrophilic while picking the coated objects and reverse or “switch” to hydrophobic when placing them. It should be noted that by increasing the number of switching nodes per unit area, higher forces can be generated.

In one embodiment, the system comprises a power source component, a voltage amplifier component configured to produce voltage when powered by the power source component, and a material handling component. The material handling component includes one or more electrically controlled nodes, wherein the one or more electrically controlled nodes comprises an electrode element coated with a dielectric element and a hydrophobic element. The one or more electrically controlled nodes is configured to be hydrophilic when voltage is applied by the voltage amplifier component in order to pick up the one or more objects and the one or more electrically controlled nodes is configured to be hydrophobic when voltage is discontinued from the voltage amplifier component in order to place the one or more objects. Certain embodiments of the invention may also include a switch component to control nodes individually or in combination.

One advantage of the system according to the invention is that objects can be selected and placed with micro scale precision. It is contemplated that the invention may assist three-dimensional (3D) printers as well as be used to pick and place heavy objects.

Another advantage of the invention is that the system according to the invention accommodates high-volume assembly of micron sized objects since the system is able to quickly change between a hydrophilic force to pick-up a micron sized object and a hydrophobic force to drop-off micron sized objects.

Another advantage of the invention is that the system exhibits a quick response time.

Yet another advantage of the invention is that the system has the ability to control millions of micron sized objects including the ability to control each object independently from another.

Yet another advantage of the invention is the system's self-cleaning ability by the virtue of adhesion switching. Specifically, the system is hydrophobic in a ground state, which drives away aqueous remains.

The invention and its attributes and advantages may be further understood and appreciated with reference to the detailed description below of contemplated embodiments, taken in conjunction with the accompanying drawing.

### DESCRIPTION OF THE DRAWING

The accompanying drawings, which are incorporated in and constitute a part of this specification, illustrate an implementation of the invention and, together with the description, serve to explain the advantages and principles of the invention:

FIG. 1 is a block diagram illustrating the system according to one embodiment of the invention.

FIG. 2 illustrates a material handling component of the system according to one embodiment of the invention.

FIG. 3 is a diagram illustrating electrostatically actuated wetting according to one embodiment of the invention.

FIG. 4 is a more detailed diagram illustrating electrostatically actuated wetting according to one embodiment of the invention.

FIG. 5 illustrates an object in equilibrium with capillary forces according to one embodiment of the invention.

FIG. 6 is a diagram illustrating the analogy between electrowetting and capacitance-resistance circuit according to one embodiment of the invention.

FIG. 7 illustrates a material handling component design according to one embodiment of the invention.

FIG. 8 illustrates multiplexing according to one embodiment of the invention.

### DETAILED DESCRIPTION OF THE INVENTION

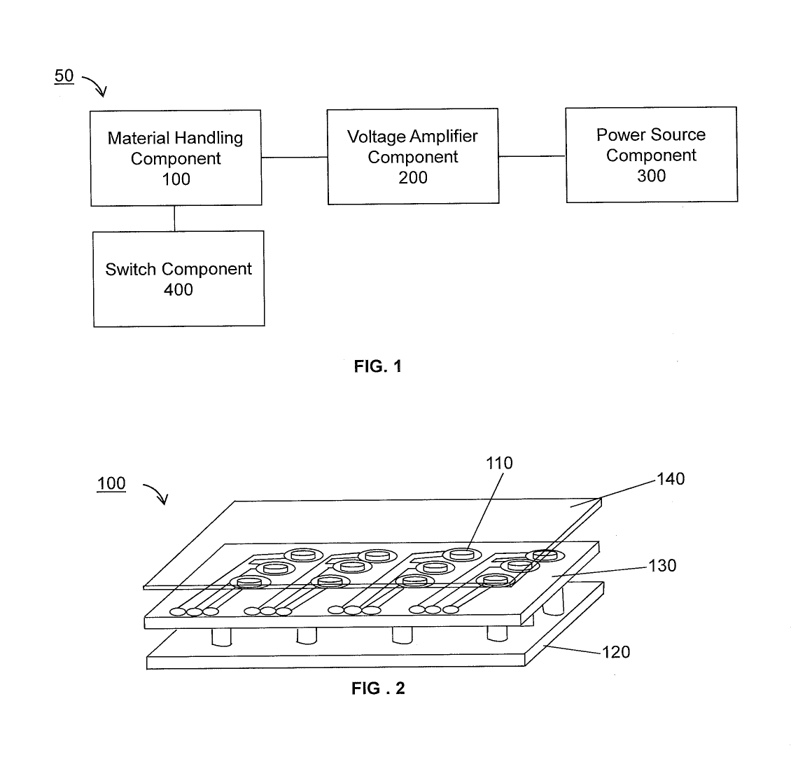

FIG. 1 is a block diagram illustrating the system 50 according to one embodiment of the invention. As shown in FIG. 1, the system 50 includes a material handling component 100, a voltage amplifier component 200 and a power source component 300. Certain embodiments of the invention may also include a switch component 400, which may be used to control nodes individually or in combination.

Specifically, the system of the invention includes a material handling component 100, such as a dielectric substrate, comprising one or more electrically controlled nodes 110 as shown in FIG. 2. The one or more electrically controlled nodes 110 comprise an electrode element 120 coated with a dielectric element 130 and a hydrophobic element 140.

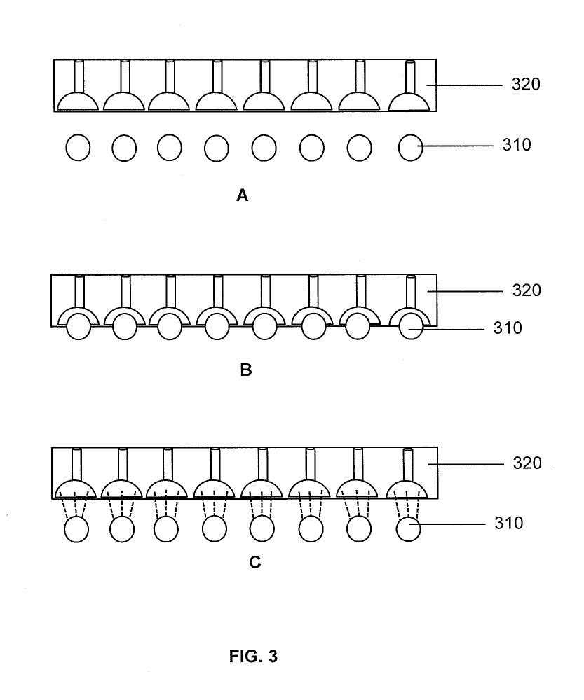

FIG. 3 is a diagram illustrating electrostatically actuated wetting according to one embodiment of the invention. A conducting droplet 310 used to coat objects to be picked up and one or more electrically controlled nodes 320 are shown in FIG. 3A. The one or more electrically controlled nodes 320 are hydrophilic when voltage is applied by the voltage amplifier component in order to pick up the one or more objects through the conducting droplet 310 as shown in FIG. 3B. The one or more electrically controlled nodes 320 are hydrophobic when voltage is discontinued from the voltage amplifier component in order to place the one or more objects through the conducting droplet 310 as shown in FIG. 3C.

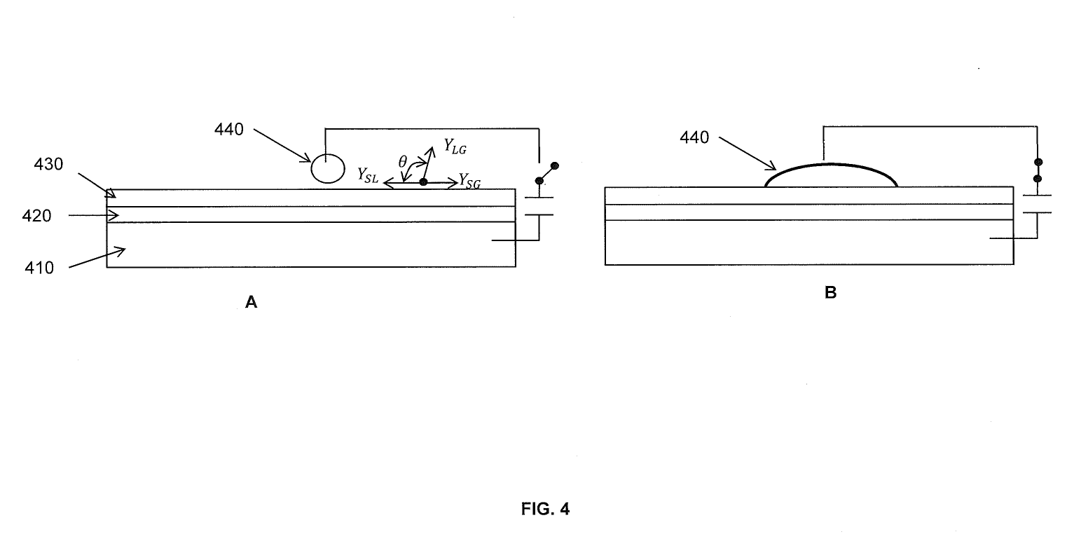

FIG. 4 is a more detailed diagram illustrating electrostatically actuated wetting according to one embodiment of the invention. More specifically, an electrical double layer (EDL) enhances the surface tension resulting in the spreading of a droplet 440 across the object as can be seen in FIG. 4B. The term EDL refers to a structure with variation of electric potential near a surface. By coating the electrode element 410 with a dielectric element 420 and a hydrophobic element 430 including droplet 440, not just the actuation power multiplies; it empowers to manipulate a droplet of any conductivity. The development of EDL enhances the surface tension γ_{SL} resulting in the spreading of the droplet. A dielectric element positioned between the electrode element and droplet mimics like an EDL except that the voltage droplet registered across the dielectric can be much higher than across an EDL, which is the key to efficient adhesion switching on a dielectric surface.

A capacitor model of electrowetting suggests:

$${γ}_{SL} = {γ}_{SL}^{o} - \frac{1}{2} \frac{{ε}_{d}}{t} {V}^{2}$$

where ∈_{d} is the permittivity of EDL, l is thickness of EDL and γ_{SL}^{o} is the solid-liquid surface energy in the absence of an electric field. When combined with the Young's equation of triple junction stability, it gives the modified contact angle:

$$cos ( {θ}_{SL} ) = cos ( {θ}_{SL}^{o} ) + \frac{1}{2} \frac{{ε}_{d}}{t {γ}_{LG}^{o}} {V}^{2}$$

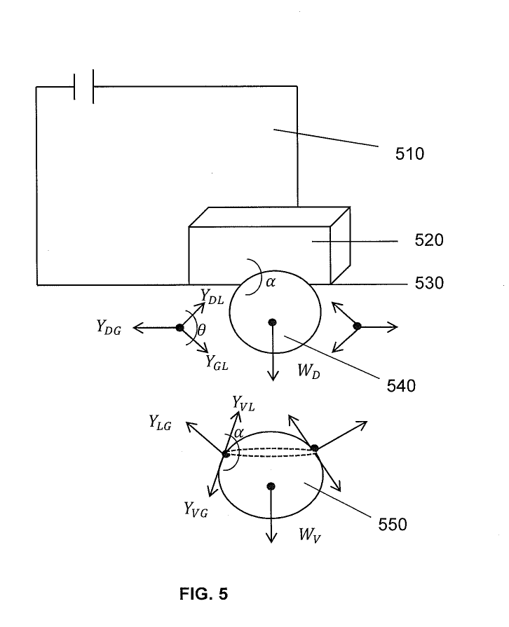

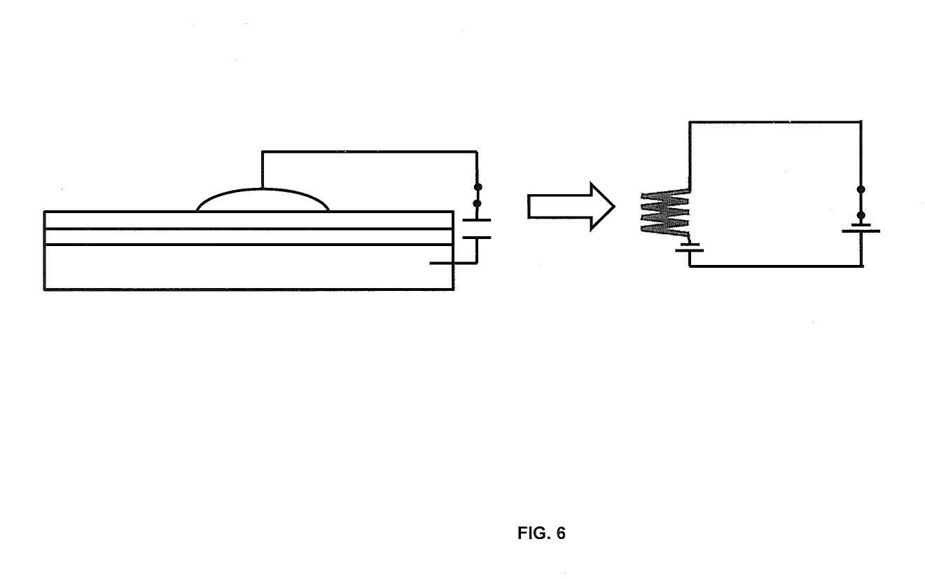

A simple free diagram for the picking process is given in FIG. 5 illustrating an object in equilibrium with capillary forces. Specifically, FIG. 5 illustrates an electrode element 510 coated with a dielectric element 520 and a hydrophobic element 530 including a droplet 540 for coating the object 550, which is shown in equilibrium.

Intuitively the meniscus between an object and the material handling component should have a curvature on the sides which would create a lower pressure inside the droplet. This effect dominates rest of the capillary forces if the weight of object is too high; however, this effect is ignored. Other assumptions includes the curvature of the picking slot on the material handling component is same as that of the object. Thus, the force analysis boils down to following equation:

2πR(γ_{GL} cos θ−γ_{DL})sin²α=W_{Tiles}

The object is represented by V, the droplet by L, the dielectric D, and the surrounding gas phase by G. To incorporate the geometry and material property of the objects, the above expression is modified to the following form:

$$2 π R ( {γ}_{GL} cos θ - {γ}_{DL} ) {sin}^{2} α = \frac{4}{3} π {R}^{3} {ρ}_{Tiles} g$$

The wetting angle θ is a function of the potential V maintained across the electrodes. An electrowetting equation is evoked to get the expression dependent on V.

$$2 π R ( {γ}_{GL} cos {θ}_{o} + \frac{1}{2} \frac{{ε}_{D}}{t {γ}_{LG}^{o}} {V}^{2} - {γ}_{DL} ) {sin}^{2} α = \frac{4}{3} π {R}^{3} {ρ}_{Tiles} g$$

$$\frac{1}{2} \frac{{ε}_{D}}{t {γ}_{LG}^{o}} {V}^{2} {sin}^{2} α = ( {γ}_{DL} - {γ}_{GL} cos {θ}_{o} ) {sin}^{2} α + \frac{2}{3} {R}^{2} {ρ}_{Tiles} g$$

In the above equation, α is a function of surface tension properties associated with the object material.

$$sin α = \frac{\sqrt{{( {γ}_{VL} - {γ}_{VG} )}^{2} - {γ}_{VL}^{2}}}{{γ}_{LG}}$$

Effectively, the following equation is obtained in terms of all the known physical parameters:

$$\frac{1}{2} \frac{{ε}_{D}}{t {γ}_{LG}^{o}} {V}^{2} {sin}^{2} α = ( {γ}_{DL} - {γ}_{GL} cos {θ}_{o} ) {sin}^{2} α + \frac{2}{3} {R}^{2} {ρ}_{Tiles} g$$

$$V = {[ \frac{2 t {γ}_{LG}^{2}}{{ε}_{D}} \frac{( ( {γ}_{DL} - γ AL cos {θ}_{o} ) {sin}^{2} α + \frac{2}{3} {R}^{2} {ρ}_{g} )}{\sqrt{{γ}_{VL}^{2} - {( {γ}_{VL}^{2} - {γ}_{VA}^{2} )}^{2}}} ]}^{\frac{1}{2}}$$

An advantage of the invention is that the droplets face the object such that the electrodes lie on the same side of the dielectric element.

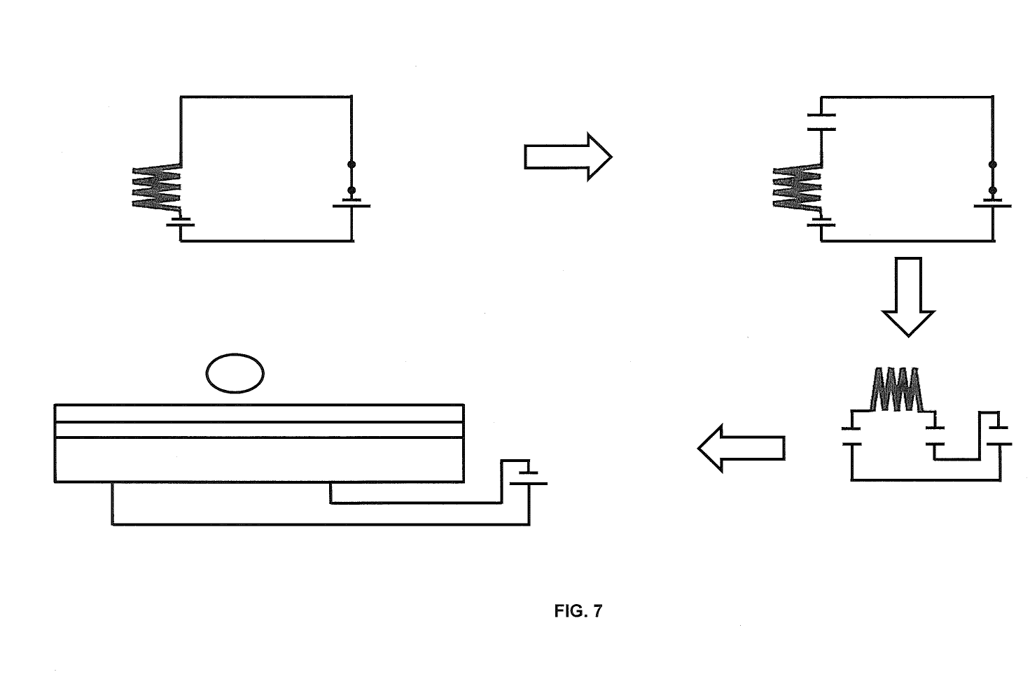

FIG. 6 is a diagram illustrating the analogy between electrowetting and capacitance-resistance (CR) circuit according to one embodiment of the invention. Specifically, FIG. 6 draws an analogy between a real capacitor-resistance circuit and the classical electrowetting experimental set up. The dielectric element can be thought of as a capacitor and the conducting droplet as a “resistance”. Similarly another circuit can be thought of with two capacitors and a resistance in between.

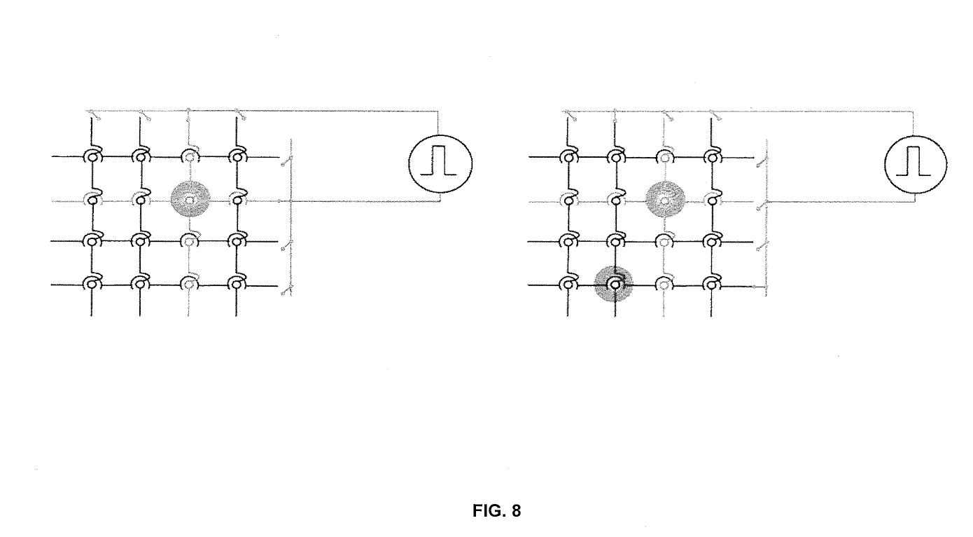

FIG. 7 illustrates a material handling component design according to one embodiment of the invention. Not only are the two electrodes are on same side, it also has faster switching time. One embodiment of the material handling component comprises of a capacitor C and a resistance R, giving a switching time τ˜CR. In another embodiment, the material handling component has two capacitors C and a resistor R with net capacitance C/2 and hence switching time

$$τ \sim \frac{CR}{2} .$$

This assumes that droplet size is same and ignores the fact that capacitor also depends on the area of two capacitor plates.

FIG. 8 illustrates multiplexing according to one embodiment of the invention. A droplet once actuated to hydrophilic nature remains hydrophilic even if the system is switched off. This means, for example, that 1000×1000 objects can be independently controlled by 2000 switches. This allows for massive parallelization, albeit with accommodating circuitry.

A unique behavior is observed with the invention. The wetting property till was retained until a short circuit occurred. This observation is critical to massive parallelization of picking and placing objects. The “retention till shorted” can be exploited to multiplex the actuation. For example, manipulating an array of n×n nodes independently of each other may include 2n² wires coming of the material handling component whose switching is controlled by n² switch components. This type of wiring is necessary only if a continuous supply of power is required to retain the objects at their position. Because a pulse is sufficient to trigger the picking, a scheme as shown in FIG. 8 can be employed. This requires just 2n switch components and can be further reduced to 4 log(n) switch components by deploying a particular multiplexing method.

The described embodiments are to be considered in all respects only as illustrative and not restrictive, and the scope of the invention is not limited to the foregoing description. Those of skill in the art may recognize changes, substitutions, adaptations and other modifications that may nonetheless come within the scope of the invention and range of the invention.

1. A system comprising the use of electrowetting to manipulate one or more objects, the system comprising:
a power source component;
a voltage amplifier component configured to produce voltage when powered by the power source component;
a material handling component including one or more electrically controlled nodes, wherein the one or more electrically controlled nodes comprises an electrode element coated with a dielectric element and a hydrophobic element, the one or more electrically controlled nodes configured to be hydrophilic when voltage is applied by the voltage amplifier component in order to pick up the one or more objects and the one or more electrically controlled nodes configured to be hydrophobic when voltage is discontinued from the voltage amplifier component in order to place the one or more objects.

2. The system comprising the use of electrowetting to manipulate one or more objects according to claim 1 further comprising a switch component to control the electrode element.
